(19) United States
(12) Patent Application Publication
(10) Pub. No.: US 2006/0244319 A1
(43) Pub. Date: Nov. 2, 2006

(54) Electric wheel structure assembly method of use

(76) Inventors: Dong-Liang Guo, Jiaxing City (CN); Kang Lu, Jiaxing City (CN); Min-Huang Lin, Jiaxing City (CN); Ta-Chin Song, Jiaxing City (CN)

Correspondence Address: TROXELL LAW OFFICE PLLC, SUITE 1404, 5205 LEESBURG PIKE, FALLS CHURCH, VA, 22041, US

(21) Appl. No.: 11/117,364

(22) Filed: Apr. 29, 2005

(51) Int. Cl. B60K 1/00; H02K 11/00; H02K 23/04

(52) U.S. Cl. 310/68 B; 310/268; 310/154.06; 180/65.1

(57) ABSTRACT

The present invention directly utilizes a transmission device as a hub of a wheel to prevent falling off a roller chain and be kept from annoying sounds out of rustiness while having a simple structure, a light weight, a small size and a steady transmission.

### FIELD OF THE INVENTION

The present invention relates to an assembly method of use; more particularly, relates to directly utilizing a transmission device as a hub of a wheel while having a simple structure, a light weight, a small size and a steady transmission.

### DESCRIPTION OF THE RELATED ARTS

Transmission devices according to prior arts can be divided into two categories. A transmission device from one of the categories, as shown in FIG. 9, can comprise a small gear 73 deposed at a side of an axle 72 which is at the center of a wheel 71 of a vehicle 7; a driving motor 75 which is located at a proper place of the vehicle 7 and is comprised with a big gear 74; and a roller chain 76 which is being circled around the big gear 74 and the small gear 73 to connect both. When the driving motor 75 rolls, the big gear 74 is jointly rolled to roll the roller chain 76 which rolls the small gear 73 as well to roll the wheel 71.

A transmission device from the other category, as shown in FIG.10, can comprise a small gear 73 deposed at a side of an axle 72 which is at the center of a wheel 71 of a vehicle 7; a motor 77 which is deposed at a place of the vehicle 7 near the wheel 71; and a transmitting gear 79 which is engaged with the small gear 73 on the axle 78 of the motor 77. When the motor 77 is powered by an outside electric power source to roll the axle 78, the transmitting gear 79 is rolled to roll the small gear 73 so that the wheel 71 is engaged to roll as well.

Although the above wheel structures for transmission devices can roll the wheel 71, the transmitting methods with the coordination of the big and the small gears 74,73 and the roller chain 76 is apt to make the roller chain 76 fall off while the roller chain 76 needs to be oiled periodically to be kept from annoying sounds out of rustiness. Because the transmission is done by rolling the small gear 73 which is engaged with the roller chain 79 on the axle 79 of the motor 77, abrasion happens between the roller chain 79 and the small gear 73 so that a striping-off and a speed error may happen between the roller chain 79 and the small gear 73. In addition, the above wheel structures are complex and add weight to the vehicle 7 so that the prior arts do not fulfill users' requests on actual use.

### SUMMARY OF THE INVENTION

Therefore, the main purpose of the present invention is to provide a transmission device to be used as a hub of a wheel while having a simple structure, a light weight, a small size and a steady transmission.

To achieve the above purpose, the present invention is an assembly method of use for an electric wheel structure, comprising a wheel and a transmission device which is comprised with a sensor unit and is set at the center of the wheel. Therein, the transmission device comprises a case fixed on the inner end surface of the wheel; an axle of movability penetrates the case at the center; a coreless wound stator is deposed on the axle 22 and is connected with a coil for obtaining an outside power source; a collar plate is deposed in the case and is respectively corresponding to each end surface of the core less wound stator; a permanent magnet corresponding to the coreless wound stator is deposed on the collar plate; and the sensor unit is to sense the state of the magnetic pole of the core less wound stator.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a perspective view according to a preferred embodiment of the present invention;

FIG. 2 is an explosive view of a first preferred embodiment of a transmission device according to the present invention;

FIG. 3 is a cross-sectional view of the first preferred embodiment of a transmission device according to the present invention;

FIG. 4 is a cross-sectional view of a second preferred embodiment of a transmission device according to the present invention;

FIG. 5 is a perspective view showing a sensor unit for back electromotive force according to another preferred embodiment of the present invention;

FIG. 6 is a view of an assembly according to the present invention;

FIG. 7 is a view of an open loop control according to the present invention;

FIG. 8 is a view of a close loop control according to the present invention;

FIG. 9 is a perspective view according to a prior art; and

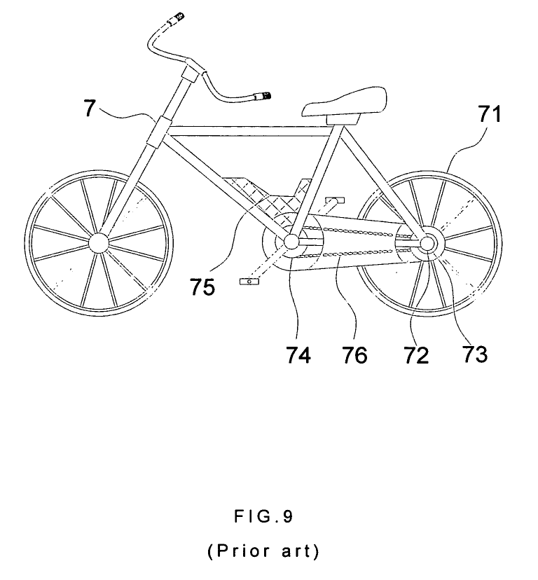

FIG. 10 is a perspective view according to an other prior art.

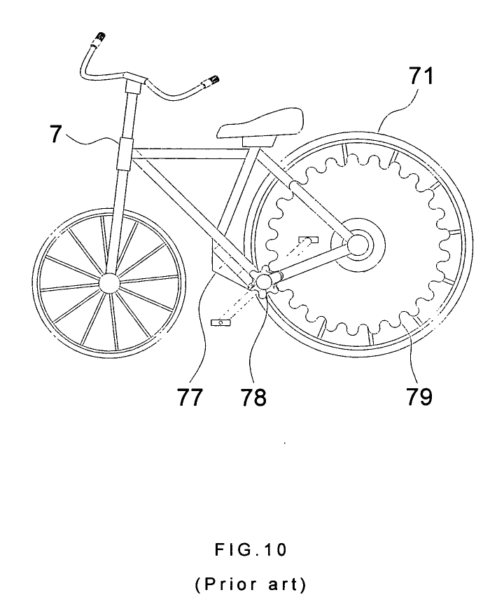

### DESCRIPTION OF THE PREFERRED EMBODIMENTS

The following descriptions of the preferred embodiments are provided to understand the features and the structures of the present invention.

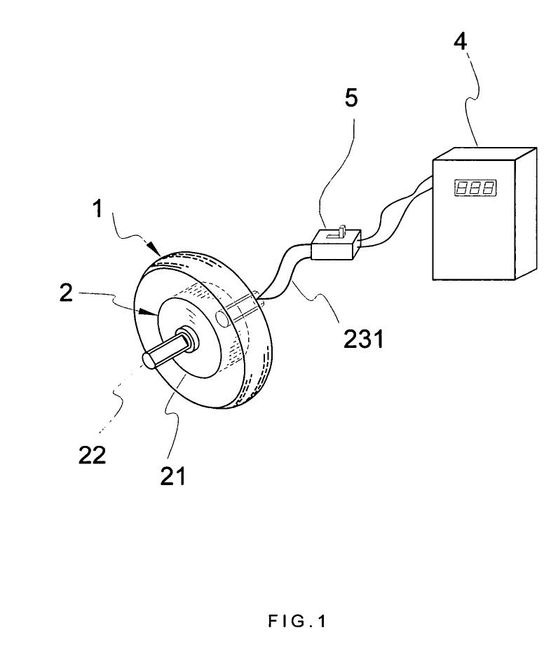

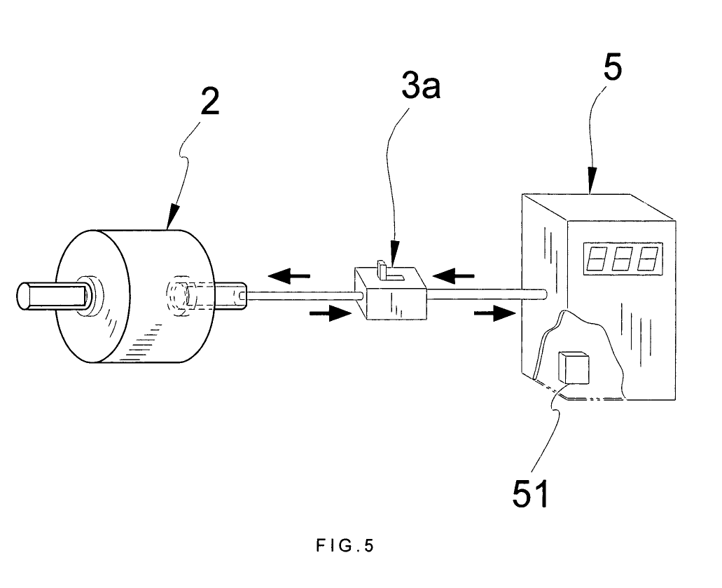

Please refer to FIG. 1 till FIG. 5, which are a perspective view of a preferred embodiment, an explosive view of a first preferred embodiment of a transmission device, cross-sectional views of a first and a second preferred embodiments of a transmission device, and a perspective view of another preferred embodiment showing a sensor unit for back electromotive force, according to the present invention. As shown in the figures, the present invention is an assembly method of use for an electric wheel structure, comprising obtaining a wheel 1 and a transmission device 2 with a sensor unit 3, where the transmission device 2 can be used directly as a hub for the wheel 1 while having a simple structure, a light weight, a small size and a steady transmission.

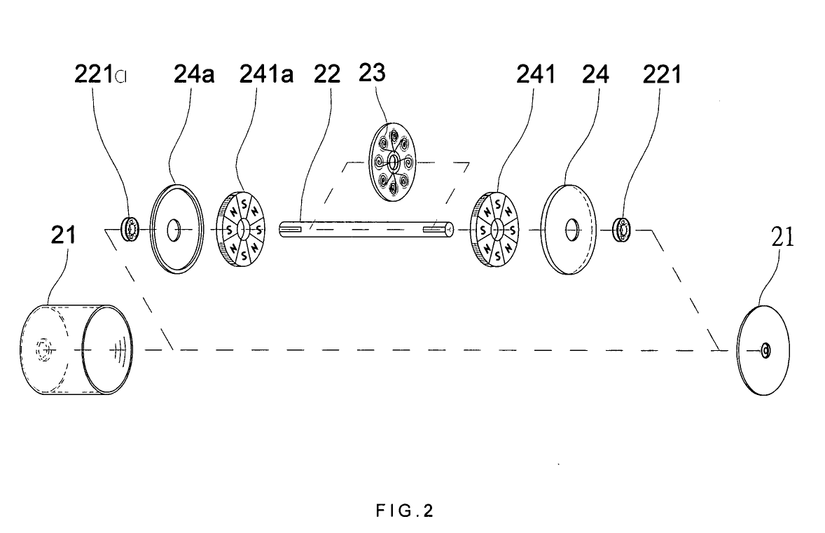

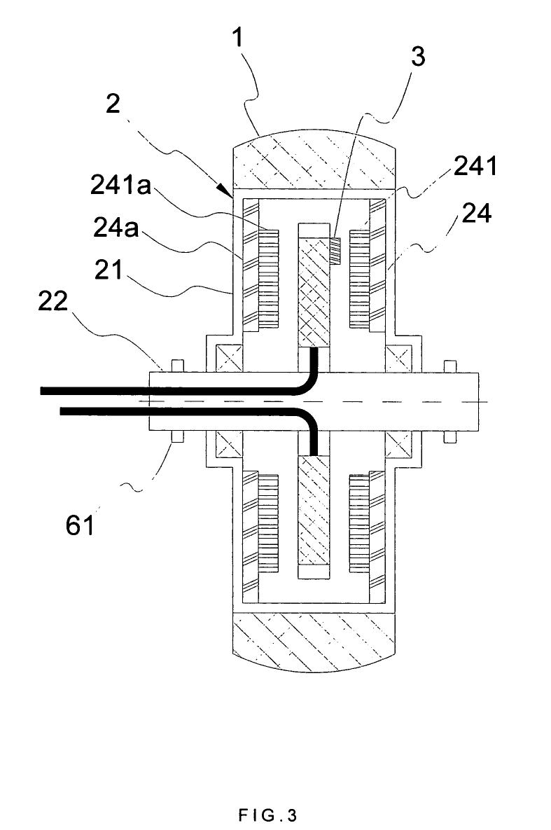

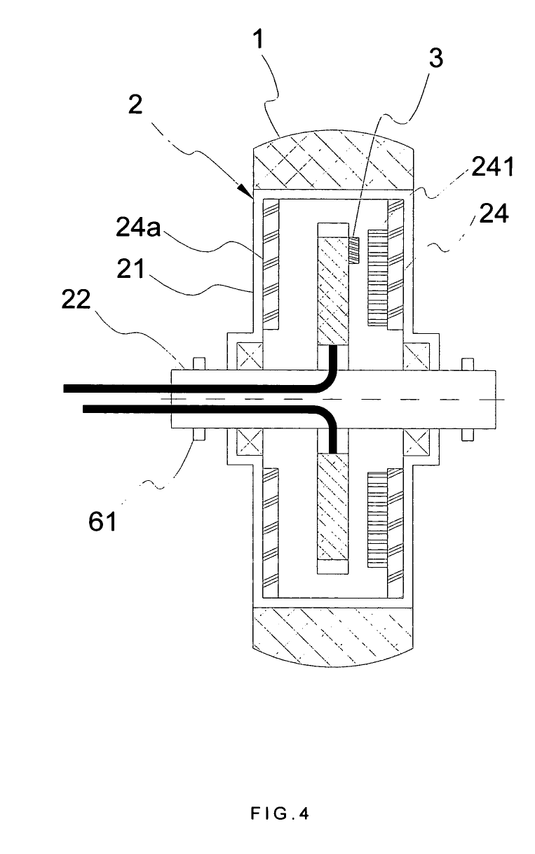

Therein, the transmission device 2 is deposed at center of the wheel 1; the transmission device 2 comprises a case 21 fixed on the inner end surface of the wheel 1; an axle 22 of movability penetrates the case 21 at the center; a bearing 221,221a is located respectively between the case 21 and each end of the axle 22; a coreless wound stator 23 is deposed on the axle 22 and is connected with a coil 231 for obtaining an outside power source; a collar plate 24,24a is deposed in the case 21 and is respecttively corresponding to each end surface of the coreless wound stator 23; a permanent magnet 241 corresponding to the coreless wound stator 23 is deposed on one collar plate 24(as shown in FIG. 4), or two permanent magnets 241,241a on both collar plates 24,24a (as shown in FIG. 2 and FIG. 3), to keep a shortest magnetic circuit to the axle; and, the transmission device 2 can be connected to a control unit 4 so that a loop is formed to control the rotation speed of the transmission device 2.

The sensor unit 3 can be set on the coreless wound stator 23 (as shown in FIG. 3 and FIG. 4) for sensing the state of the magnetic pole of the coreless wound stator 23 which is corresponding to the permanent magnet 241(,241a). The sensor unit can be a positioning sensor, such as a Hall element or a photo positioning sensor. The inverter 5 is connected to the sensor unit 3 to obtain the state of the magnetic pole of the coreless wound stator 23 sensed by the sensor unit 3 to control the field commutating time of the coreless wound stator 23. Or, the sensor unit 3a can sense a commutation of a coreless wound stator 23 by a back electromotive force (as shown in FIG. 5); and an inverter 5 is comprised with a detecting unit 51 to be informed of the back electromotive force. Accordingly, a novel assembly method of use for an electric wheel structure is obtained.

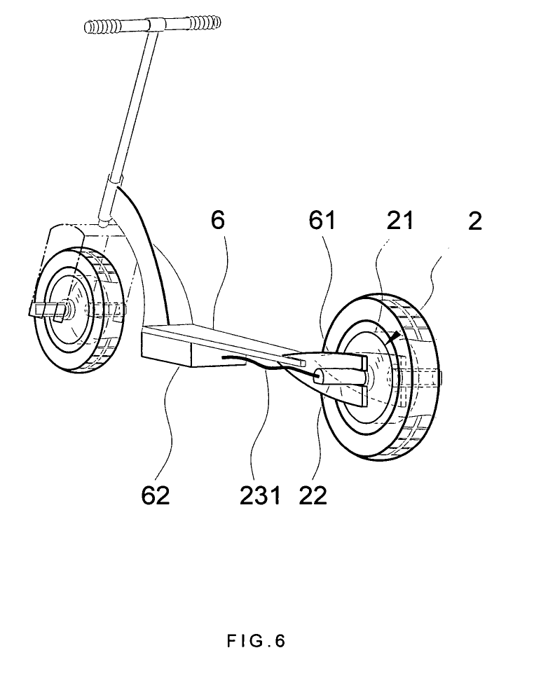

Please refer to FIG. 3 and FIG. 6, which are a cross-sectional view of a transmission device and a view of an assembly, according to the first preferred embodiment of the present invention. As shown in the figures, when assembling, a transmission device 2 fixed in a wheel 1 can be set on a supportive frame 61 of a vehicle 6 and a coil 231 of the transmission device 2 is connected to an electric power source 62 of the vehicle 6 so that the vehicle 6 having the wheel 1 and the transmission device 2 is assembled. When operating, a power from the electric power source 62 is applied to the transmission device 2 where a coreless wound stator 23 is kept being commutated according to a sensor unit 3 to continuously produce repulsive phases to a magnet 241(,241a). As a result, a case 21 of the transmission device 2 is kept rolling while rolling the wheel 1 jointly.

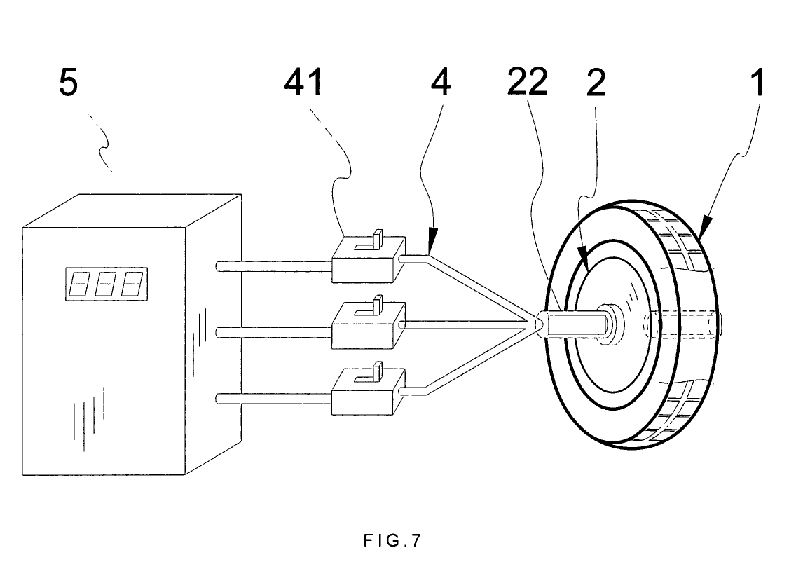

Please refer to FIG. 7, which is a view of an open loop control according to the present invention. As shown in the figure, when the present invention is applied to a vehicle 6, a control unit 4 can be set which comprises a plurality of switchers 41 with setup values for rotation speed, such as speeds of 300rpm (revolutions per minute), 600 rpm and 1200 rpm, where an open loop control can be formed by the transmission device 2, an inverter 5 and the control unit 4. When operating, a user turns on a required switcher 41 to form a loop by the transmission device 2, the inverter 5 and the switcher 41 so that the transmission device 2 can reach the required rotation speed according to the switcher 41 the user turns on. So, the changes in speed can be achieved.

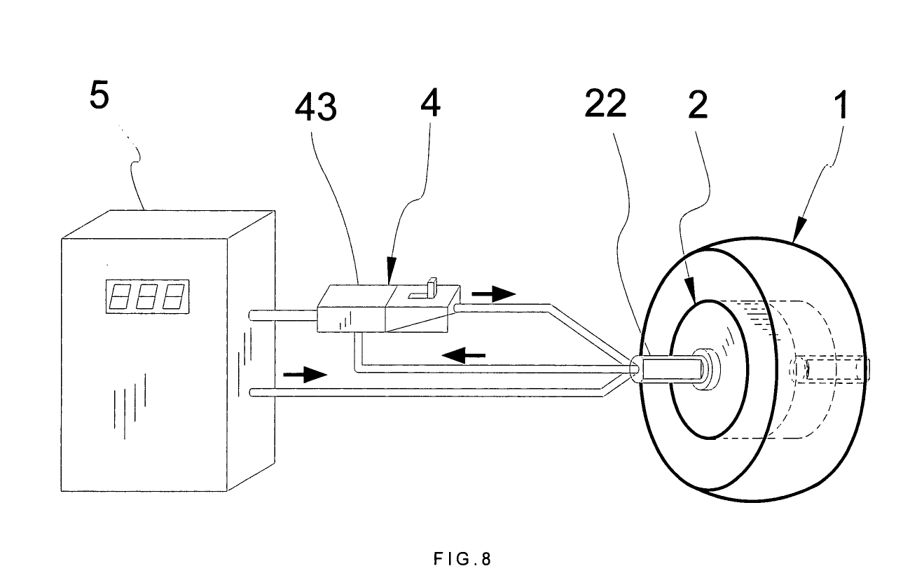

Please refer to FIG. 8, which is a view of a close loop control according to the present invention. As shown in the figure, except forming an open loop control as shown in FIG. 7, a control unit 4 can comprise a tachometer 42 connected with an axle 22 of a transmission device 2, and a differential amplifier 43 connected to the tachometer 42 and an inverter 5, so that a close loop control is formed by the transmission device 2, the inverter 5 and the control unit 4. When operating, a value for rotation speed is setup in the differential amplifier 43. As the transmission device 2 is turned on and powered, it is rotated in a speed according to the setup value. According to the rotation speed of the transmission device 2 reported promptly and continuously in the feedbacks of the tachometer 42 to the differential amplifier 43, the rotation speed error to the setup rotation speed is analyzed. If the error amount is getting smaller, the commutation speed is turned smaller by the inverter 5 so that the rotation speed can reach the set up value. On the contrary, if the error amount is getting bigger, the commutation speed is turned greater by the inverter 5 so that the rotation speed can reach the setup value.

To sum up, the present invention is an assembly method of use for an electric wheel structure, where a transmission device can be used directly as a hub for a wheel while having a simple structure, a light weight, a small size and a steady transmission.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present inventtion.

What is claimed is:

1. An assembly method of use for an electric wheel structure, comprising:
obtaining a wheel;
obtaining a transmission device, said transmission device deposed at center of said wheel, said transmission device comprising a case fixing said transmission device in said wheel, said case penetrated by an axle of movability at center of said case, a coreless wound stator deposed on said axle, said coreless wound stator connected with a coil obtaining an outside electric power source, a collar plate located in said case, said collar plate respectively corresponding to each end surface of said coreless wound stator, a permanent magnet deposed on at least one said collar plate, said permanent magnet corresponding to said coreless wound stator; and
obtaining a sensor unit, said sensor unit sensing a state of a magnetic pole of said coreless wound stator.

2. The assembly method of use according to claim 1, wherein a bearing is respectively located between said case and each end of said axle.

3. The assembly method of use according to claim 1, wherein said sensor unit is connected to an inverter; said state of said magnetic pole of said coreless wound stator is sensed by said sensor unit; and, said inverter is to obtain said state to control a field commutating time of said core less wound stator.

4. The assembly method of use according to claim 3, wherein said inverter comprises a detecting unit to be informed of a back electromotive force.

5. The assembly method of use according to claim 1, wherein said sensor unit comprises a positioning sensor selected from a group consisting of a Hall element and a photo positioning sensor.

6. The assembly method of use according to claim 1, wherein said sensor unit is deposed on said coreless wound stator.

7. The assembly method of use according to claim 1, wherein a commutation of said core less wound stator is sensed by said sensor unit through a back electromotive force.

8. The assembly method of use according to claim 1, wherein said transmission device comprises a control unit; and said control unit is located between and connected to said transmission device as well as said inverter to form a loop to control a rotation speed of said transmission device.

9. The assembly method of use according to claim 8, wherein said control unit comprises a plurality of switchers to control a rotation speed of said transmission device; and, an open loop control is formed by said transmission device, said inverter and said control unit.

10. The assembly method of use according to claim 8, wherein said control unit comprises a tachometer and a differential amplifier; said tachometer is connected with said axle of said transmission device; said differential amplifier is connected to said tachometer and said inverter; and, a close loop control is formed by said transmission device, said inverter and said control unit.
